(19) United States
(12) Patent Application Publication
(10) Pub. No.: US 2008/0147906 A1
(43) Pub. Date: Jun. 19, 2008

(54) DMA Transferring System, DMA Controller, and DMA Transferring Method

(75) Inventor: Tatsuji Hamamura, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/866,576

(22) Filed: Oct. 3, 2007

(30) Foreign Application Priority Data
Dec. 13, 2006 (JP) 2006-335545

(51) Int. Cl. G06F 13/28

(52) U.S. Cl. 710/22

(57) ABSTRACT

A DMA transferring system with a plurality of devices, the devices being connected to each other by a data transmission line, where DMA transferring is performed among the devices includes a DMA controller provided in each of the devices performing the DMA transferring and configured to implement a DMA command of write transferring. The DMA controller includes a part configured to, in a case where a DMA command of read transferring is selected, send the DMA command of read transferring to the DMA controller of one of the devices sending data of the read transferring; and a part configured to perform DMA transferring by changing the DMA command of read transferring received from the DMA controller of another of the devices to a DMA command of write transferring in the one of the device sending the DMA command.

### BACKGROUND OF THE INVENTION

1. Field of the Invention

The present invention generally relates to DMA (Direct Memory Access) transferring where data are directly transferred between a memory and another memory or a memory and an input/output device. More particularly, the present invention relates to a DMA transferring system where DMA transferring is performed between devices connected to each other by a data transmission line (bus or the like) and the transmission rate of the data transmission line used for the DMA transferring is improved, a DMA controller, and a DMA transferring method.

2. Description of the Related Art

FIG. 1 is a block diagram showing a related art (bus type) system structural example. More specifically, FIG. 1 shows a structural example of a relatively large scale system formed by independent plural devices A, B, C, . . . N connected to each other by a data transmission line (outside bus) 6-1 and configured to perform DMA transferring with other devices. In FIG. 1, a BUSx (x=a, b, c, . . . , n) represents an interface of the data transmission line (outside bus) 6-1 and a bus inside the device.

A transmission line, as shown in FIG. 1, connected to plural devices and commonly used for data transferring among plural devices is called a bus. In addition, each subscript a, b, c, . . . , n indicates providing for the device A, B, C, . . . N.

A DMAx is a DMA controller configured to control read transferring and write transferring. An MEMx is a data storage device such as a memory. A CPUx is a central processing unit configured to control the entirety of the device and send a DMA command to the DMA controller (DMAx).

The devices A, B, C, . . . N connected to each other by the data transmission line (outside bus) 6-1 are not limited to have all functions of the above-mentioned CPUx, MEMx, DMAx, and BUSx. For example, a device like the device C may not have a DMA controller (DMAx). In addition, depending on the bus type of the data transmission line (outside bus) 6-1, it may be necessary for the device to have a bus arbiter configured to arbitrate a right of use.

As an example, steps for performing the DMA transferring (data read transferring) of data from the data storage device MEMb of the device B to the data storage device MEMa of the device A by using a DMA controller DMAa of the device A are discussed with reference to FIG. 2. Here, FIG. 2 is a timing chart showing steps of related art DMA transferring (data read transferring).

First, a CPUa of the device A sends a DMA command that has a parameter necessary for DMA transferring to a DMA controller DMAa of the device A at normally plural times so as to ensure sending the DMA command, and thereby the DMA transferring is started (7-1).

The DMA controller DMAa of the device A accesses the address of the data storage device MEMb of the device B and reads data of one word from the address (7-2). The read transferring requires two transferring phases on the outside bus 6-1 where transferring directions of address sending to the data storage device MEMb of the device B via the outside bus 6-1 and data receiving from the data storage device MEMb of the device B via the outside bus 6-1 are different from each other.

Next, the DMA controller DMAa of the device A performs write transferring where one word of data obtained from the data storage device MEMb of the device B is written in the data storage device MEMa of the device A via an inside bus (7-3). In a case where data to be read remain, data transferring of the above-discussed steps 7-2 and 7-3 are repeated the number of times corresponding to the transferring word numbers (number of words to be transferred) (7-4).

If the DMA controller DMAa of the device A finishes reading all the data to be read from the data storage device MEMb of the device B, the DMA controller DMAa of the device A reports to the CPUa of the device A that the DMA transferring (data read transferring) is completed (7-5). In the example shown in FIG. 2, data transferring using the outside bus is indicated by wide line arrows and data transferring using the inside bus is indicated by narrow line arrows.

Next, steps for performing the DMA transferring (data write transferring) of data from the data storage device MEMa of the device A to the data storage device MEMb of the device B by using the DMA controller DMAa of the device A are discussed with reference to FIG. 3. Here, FIG. 3 is another timing chart showing the steps of the related art DMA transferring.

First, the CPUa of the device A sends a DMA command that is a parameter necessary for DMA transferring to the DMA controller DMAa of the device A normally plural times so as to start the DMA transferring (8-1).

The DMA controller DMAa of the device A reads one word of data to be transferred from the data storage device MEMa of the device A via the inside bus. The read transferring requires two transferring phases on the inside bus of address; sending to the data storage device MEMa of the device A via the inside bus and data receiving from the data storage device MEMa of the device A via the inside bus.

Next, the DMA controller DMAa of the device A performs write transferring of one word of data obtained from the data storage device MEMa of the device A to the data storage device MEMb of the device B (8-3). In a case where data to be read remain, data transferring of the above-discussed steps 8-2 and 8-3 are repeated the number of times corresponding to the number of transferring words numbers (8-4).

If the DMA controller DMAa of the device A finishes writing all data to be written to the data storage device MEMb of the device B, the DMA controller DMAa of the device A reports to the CPUa of the device A that the DMA transferring (data write transferring) is completed (8-5). In the example shown in FIG. 3, data transferring using the outside bus is indicated by wide line arrows and data transferring using the inside bus is indicated by narrow line arrows.

Comparing the read transferring and the write transferring with respect to use of the outside bus, while transferring is completed in the write transferring by sending the write address and write data by the outside bus in the same transferring direction, the following steps are required in the read transferring and therefore the outside bus has been and remains in use (occupied) until a data request side obtains the read data.
(1) The data request side sends the read address to the data source side by using the outside bus;
(2) The data source side prepares by reading the data of the designated read address; and
(3) The data source side sends the prepared data to the data request side by using the outside bus.

Thus, even in a case where DMA transferring of the same amount of data is performed, the occupied time of the outside bus can be shortened in the DMA transferring by the write transferring more than the DMA transferring by the read transferring. This is because, in the DMA transferring by the write transferring, transferring the write address and the write data is completed by using the outside bus only in the same transferring direction so that time for switching the data transferring direction or interpreting sent data is saved.

Japanese Laid-Open Patent Application Publication No. 54-124644 discloses a data transferring method for reducing the number of program start times and improving data transfer efficiency. In this method, a mode switching function of read/write operation is provided at an input and output control device for data transferring between a processing device and the input and output control device. Two-way data transferring between the processing device and the input and output control device is alternately performed in one WORD units by a one-time program instruction. Operations in a READ-direction and a WRITE-direction are simultaneously completed at the end of the designated number of data words.

Japanese Laid-Open Patent Application Publication No. 2005-251163 discloses an information processing system or the like where, if an information processing device is connected with another information processing device through the network, the information regarding operating status is collected from the other information processing apparatus and a device information table is made. If a predetermined command is issued, information regarding a resource required to execute the command is compared with information regarding the operating status in the device information table so that an information processing device capable of executing the command is specified and a distributed process is performed reliably and effectively among plural information processing devices.

The data transferring technique is an important technique for an information apparatus or an information processing system. In addition, the amount of data transferred is increasing year by year, requiring the use of an expensive data transferring path for high speed data transferring.

### SUMMARY OF THE INVENTION

Accordingly, embodiments of the present invention may provide a novel and useful DMA (Direct Memory Access) transferring system, DMA controller, and DMA transferring method in which one or more of the problems described above are eliminated.

More specifically, the embodiments of the present invention can provide a DMA transferring system where DMA transferring is performed between devices connected to each other by a data transmission line and usage rate or transmission rate of the data transmission line is improved so that high speed data transmission can be realized, a DMA controller, and a DMA transferring method.

In addition, the embodiments of the present invention can provide a DMA transferring system with a plurality of devices, the devices being connected to each other by a data transmission line, where DMA transferring is performed among the devices, including a DMA controller provided in each of the devices performing the DMA transferring and configured to implement a DMA command of write transferring; wherein the DMA controller includes a part configured to, in a case where a DMA command of read transferring is selected, send the DMA command of read transferring to the DMA controller of one of the devices sending data of the read transferring; and a part configured to perform DMA transferring by changing the DMA command of read transferring received from the DMA controller of another of the devices to a DMA command of write transferring in the one of the device sending the DMA command.

The embodiments of the present invention can also provide a DMA controller provided in a device connected to another device by a data transmission line and performing DMA transferring with the other device, the DMA controller being configured to implement a DMA command of write transferring; the DMA controller including: a part configured to, in a case where a DMA command of read transferring is selected, send the DMA command of read transferring to the DMA controller of the other device sending data of the read transferring; and a part configured to perform DMA transferring to the device sending the DMA command by changing the DMA command of read transferring received by the DMA controller of the other device to a DMA command of write transferring.

The embodiments of the present invention can also provide a DMA transferring method among devices connected to each other by a data transmission line, the DMA transferring method including: a step of, in a case where a DMA command of read transferring is set in a DMA controller performing the DMA command of write transferring provided in each device, sending the DMA command of read transferring to the DMA controller of the device sending data of the read transferring; and a step of performing DMA transferring to a device sending the DMA command by changing the DMA command of read transferring received from the DMA controller of other device to a DMA command of write transferring.

Other objects, features, and advantages of the present invention will become more apparent from the following detailed description when read in conjunction with the accompanying drawings.

### BRIEF DESCRIPTION OF THE DRAWINGS

FIG. 1 is a block diagram showing a related art (bus type) system structural example;

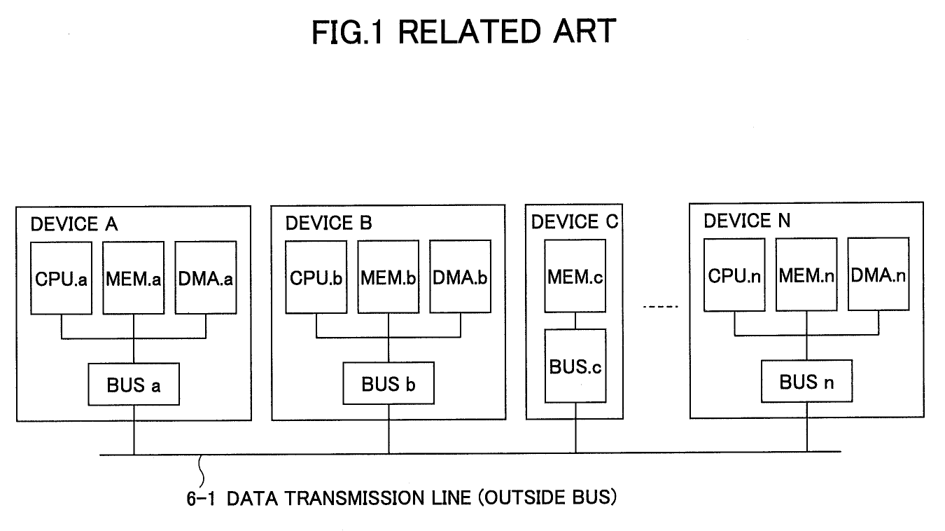

FIG. 2 is a timing chart showing steps of related art DMA transferring (data read transferring);

FIG. 3 is another timing chart showing the steps of the related art DMA transferring;

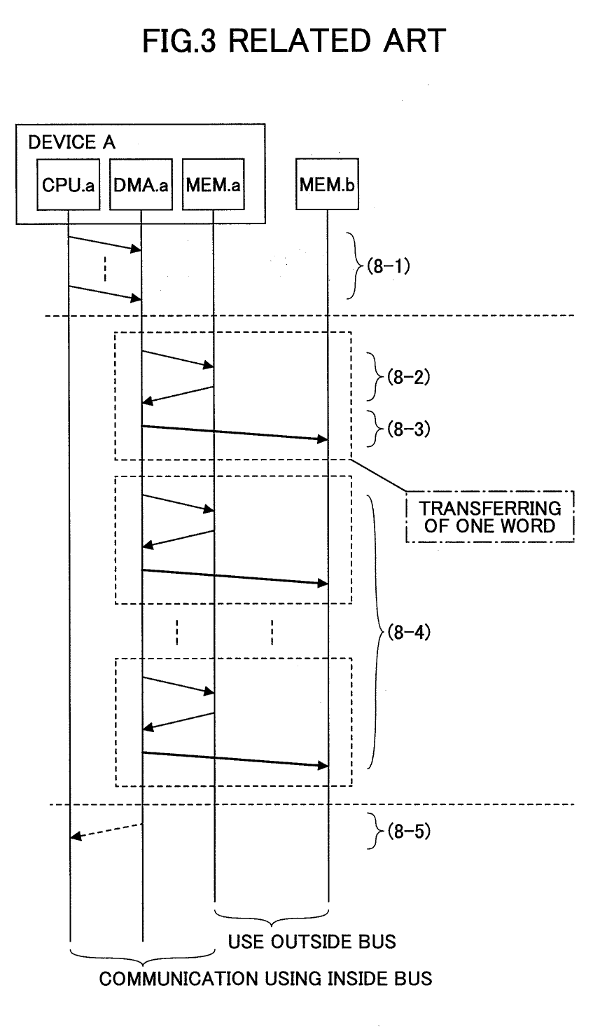

FIG. 4 is a block diagram showing a first system structural example of an embodiment of the present invention;

FIG. 5 is a view showing a structural example of a DMA command storing register RG;

FIG. 6 is a timing chart showing steps of DMA transferring (data read transferring) of an embodiment of the present invention;

FIG. 7 is a block diagram showing a second system structural example; and

FIG. 8 is a view showing functions of the DMA command storing register and a DMA command FIFO memory.

### DETAILED DESCRIPTION OF THE PREFERRED EMBODIMENT

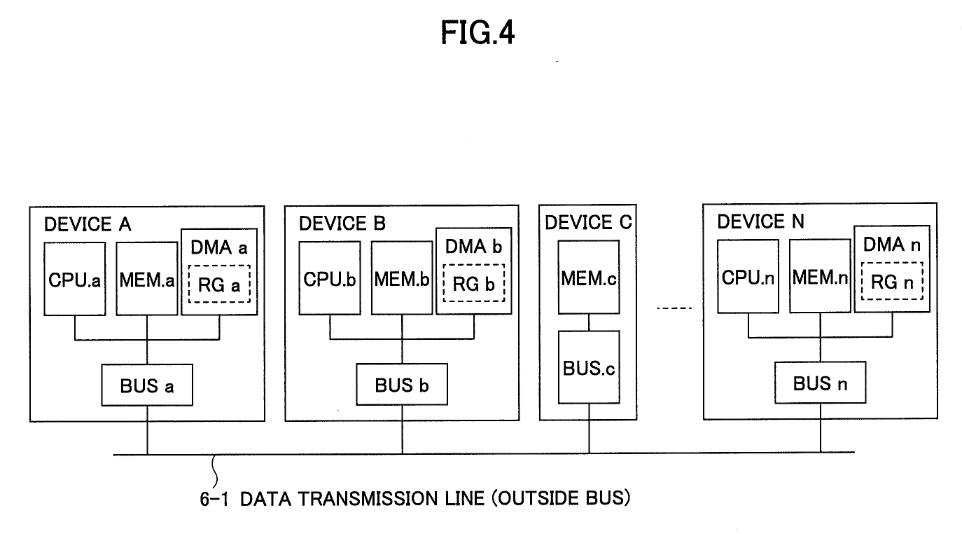

A description is given, with reference to FIG. 4 through FIG. 8, of embodiments of the present invention.

FIG. 4 is a block diagram showing a first system structural example of the embodiment of the present invention. More specifically, FIG. 4 shows the first system structural example of a system formed by independent plural devices A, B, C, . . . N connected to each other by a data transmission line (outside bus) 6-1 and configured to perform DMA transferring with other devices. In FIG. 4, a BUSx (x=a, b, c, . . . , n) represents an interface of the data transmission line (outside bus) 6-1 and a bus inside the device.

A DMAx is a DMA controller configured to control read transferring and write transferring. A MEMx is a data storage device such as a memory. A CPUx is a central processing unit configured to control the entirety of the device and send a DMA command to the DMA controller DMAx.

The DMA controller DMAx performs only the DMA write transferring. In a case where the DMA read transferring is ordered by the CPUx, the DMA command itself is transferred to the DMA controller DMAx of the device at the data source side (sending side) and data are transferred from the DMA controller DMAx of the device at the data source side by the DMA write transferring.

A DMA command storage register RGx newly added to the inside of the DMA controller DMAx of the embodiment of the present invention includes an area where a DMA command transferred from a DMA controller DMAx of another device connected to the data transmission line (outside bus) 6-1 is registered, preferably an area where at least one DMA command is registered so as to correspond to a device transferring the DMA command. It is not necessary to provide a function of the DMA controller DMAx in the device not performing the DMA transferring such as the device C.

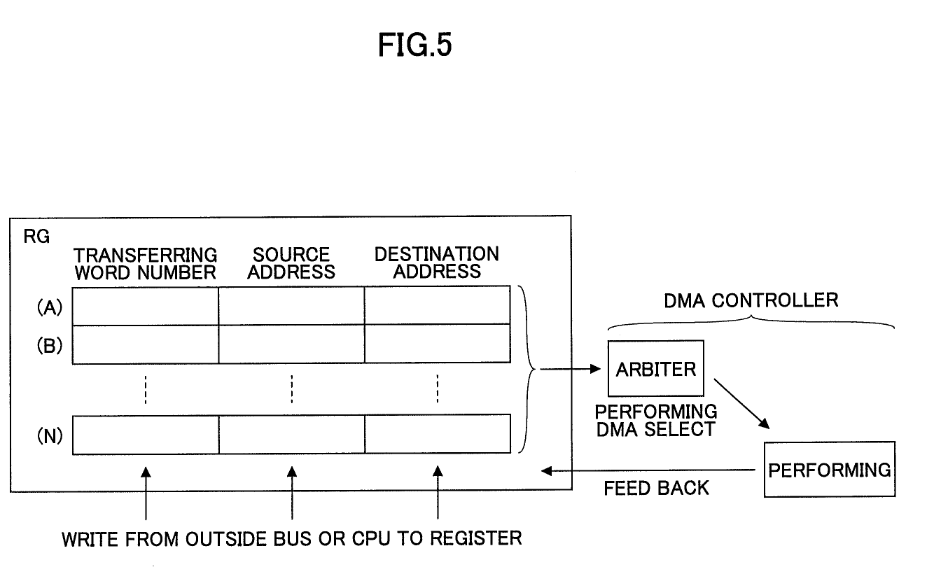

FIG. 5 is a view showing a structural example of a DMA command storing register RG. The DMA command storing register RG includes a register A for registering a DMA command from the device A, a register B for registering a DMA command from the device B, . . . , and a register N for registering a DMA command from the device N. Each register includes an area for a transferring word number, address sending the transferring data (source), and the address to which the transferring data are sent (destination).

Next, functions of the DMA controller and the DMA command storing register RG are discussed.
(1) The DMA command storing register RG registers the DMA command transferred from each device.
(2) The DMA command storing register RG reports the DMA command that can be DMA-transferred to the DMA controller. More specifically, for example, it is reported that the DMA command whose transferring word number is not zero can be DMA-transferred.
(3) The DMA controller performs conflict arbitration of the DMA commands reported from the DMA command storing register RG, including the DMA command set by the CPU of the device, in a case where plural reported DMA commands are provided, so as to perform the DMA transferring.
(4) In performing of the DMA transferring, the DMA transferring of each device is managed by directly using the register of the corresponding device of the DMA command storing register RG. After the DMA transferring is performed, contents of the register for each device of the DMA command storing register RG are renewed.

In other words, as one word is transferred, the transferring word number is decreased (decremented) one by one and source address and destination address are increased one address by one address (incremented).

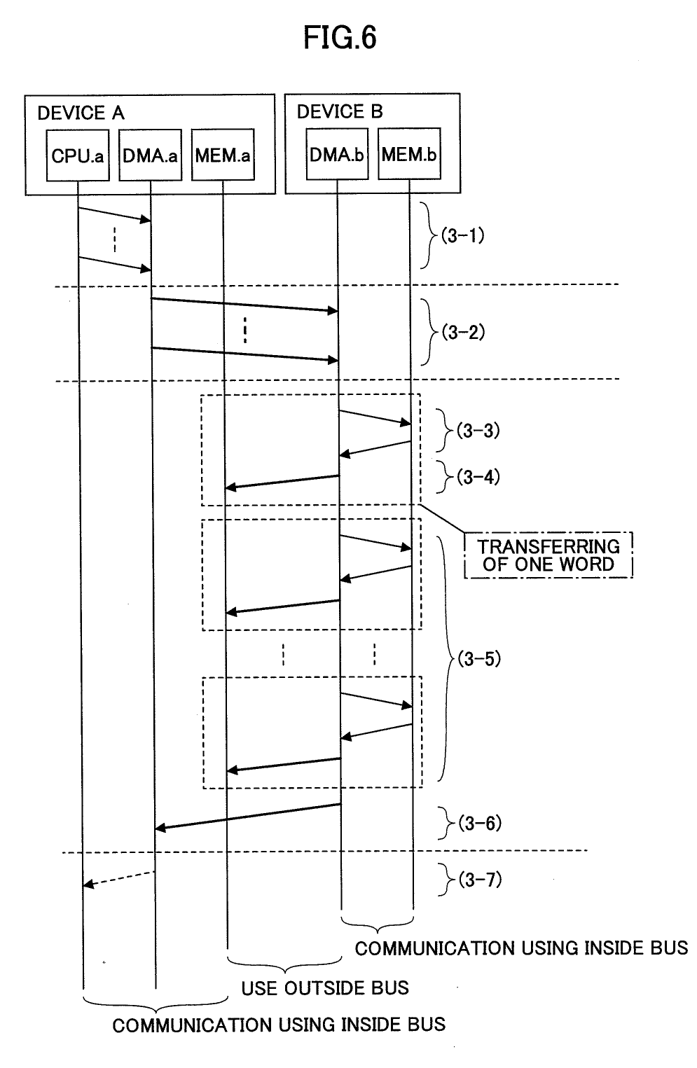

As operations of the DMA transferring in the read direction where the present invention is applied, an operation example where data of the data storage device MEMb of the device B are read and transferred to the data storage device MEMa of the device A is discussed with reference to FIG. 6. Here, FIG. 6 is a timing chart showing steps of DMA transferring (data read transferring) of an embodiment of the present invention.

While the present invention can be applied to any type of the data transmission line, an example where the data transmission line (outside bus) having both the address line and the data line is shown in FIG. 6.

The CPUa of the device A sends the DMA command of the read transferring, for transferring the data in a direction from the data storage device MEMb of the device B to the data storage device MEMa of the device A, to the DMA controller DMAa of the own device. Last, the CPUa of the device A sets the transferring word number that is a value other than zero and instructs starting the DMA command (3-1).

The DMA controller DMAa of the device A interprets the DMA command being started, recognizes the DMA transferring in the read direction from the data storage device MEMb of the device B to the data storage device MEMa of the device A, and DMA write-transfers the DMA command (read) to the DMA controller DMAb of the device B (3-2).

More specifically, the CPUa of the device A loads the destination address of the DMA command set in the DMA controller DMAa into the source address for the device A of the DMA command storing register RGb of the device B. The CPUa of the device A loads the address of the original DMA command set in the DMA controller DMAa into the destination address for the device A of the DMA command storing register RGb. Last, the CPUa of the device A loads the transferring word number set in the DMA controller DMAa into the transferring word number register for the device A of the DMA command storing register RGb.

The DMA controller DMAb of the device B accesses from the data storage device MEMb of the own device the address set in the source address register for the device A of the DMA command storing register RGb so as to read one word of the data (3-3).

Next, the DMA controller DMAb of the device B performs write transferring one word of data obtained from the data storage device MEMb of the device B to the data storage device MEMa of the device A (3-4). In a case where data to be transferred remain, data transferring of the above-discussed steps 3-3 and 3-4 are repeated the number of times corresponding to the number of transferring words (3-5).

If the DMA controller DMAb of the device B finishes transferring all data to be transferred, the DMA controller DMAb of the device B reports to the DMA controller DMAa of the device A that the DMA controller DMAb of the device B has finished transferring all data to be transferred (3-6). For example, the message is write-transferred to an exclusive register of the DMA controller DMAa. The DMA controller DMAa of the device A receiving the message send to the CPUa in the own device that the DMA transferring of the data is completed.

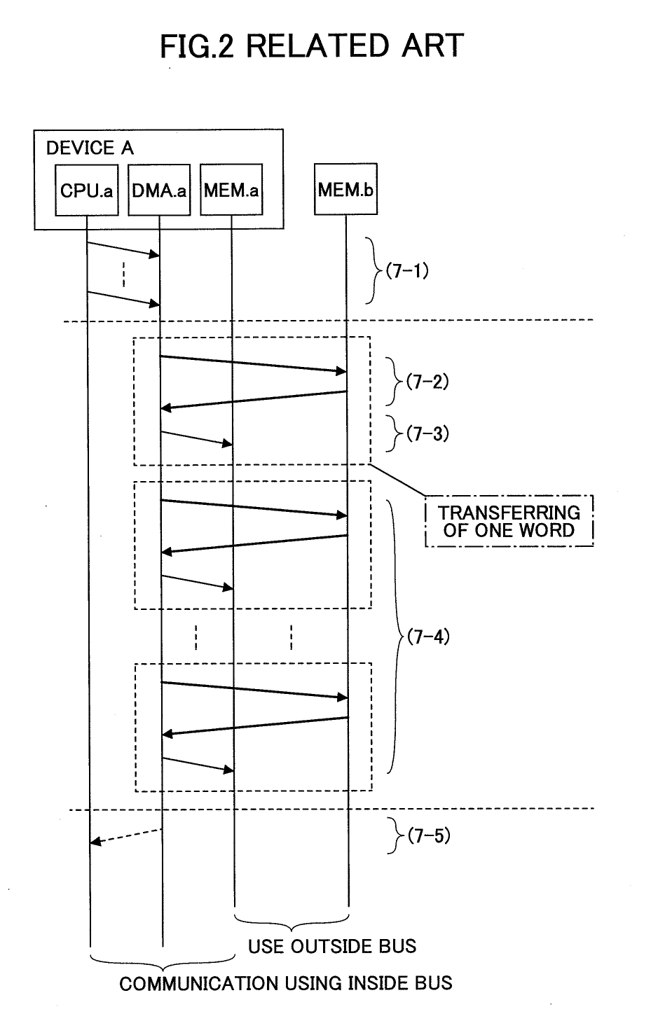

Comparing the DMA read transferring of the embodiment of the present invention shown in FIG. 6 and the DMA read transferring shown in FIG. 2, with respect to use of the data transmission line, namely the outside bus, in the DMA read transferring of the embodiment of the present invention, the transferring data are transmitted by using only the outside bus in the same transmission direction. Therefore, it is possible to decrease the ratio of use (occupation) of the data transmission line (outside bus). The more the number of transferring words is, the more the ratio of use (occupation) of the data transmission line (outside bus) can be decreased.

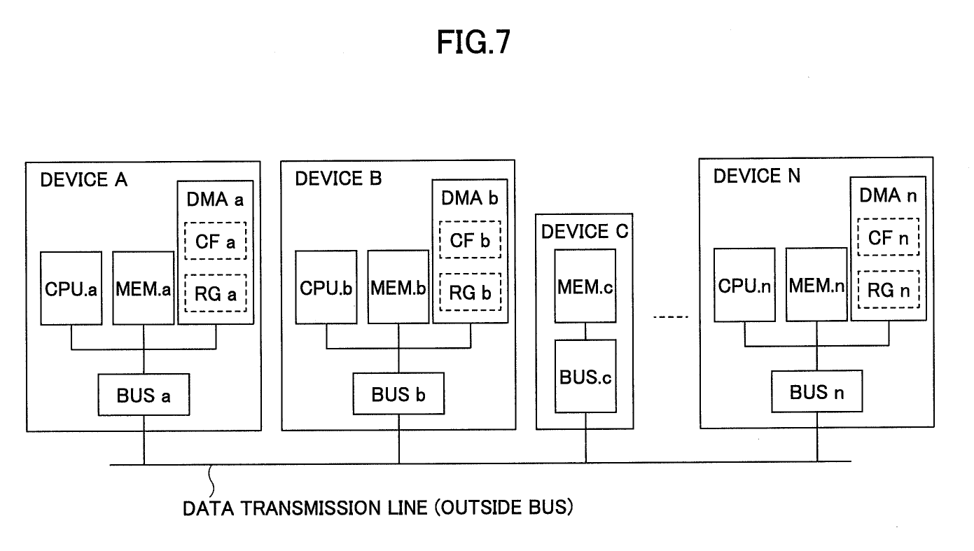

FIG. 7 is a block diagram showing a second system structural example. The difference between this example and the first example shown in FIG. 4 is that a DMA command FIFO memory CFx is newly added in the DMA controller DMAx. The DMA command FIFO memory CFx is a storing area for processing the DMA commands in registration order.

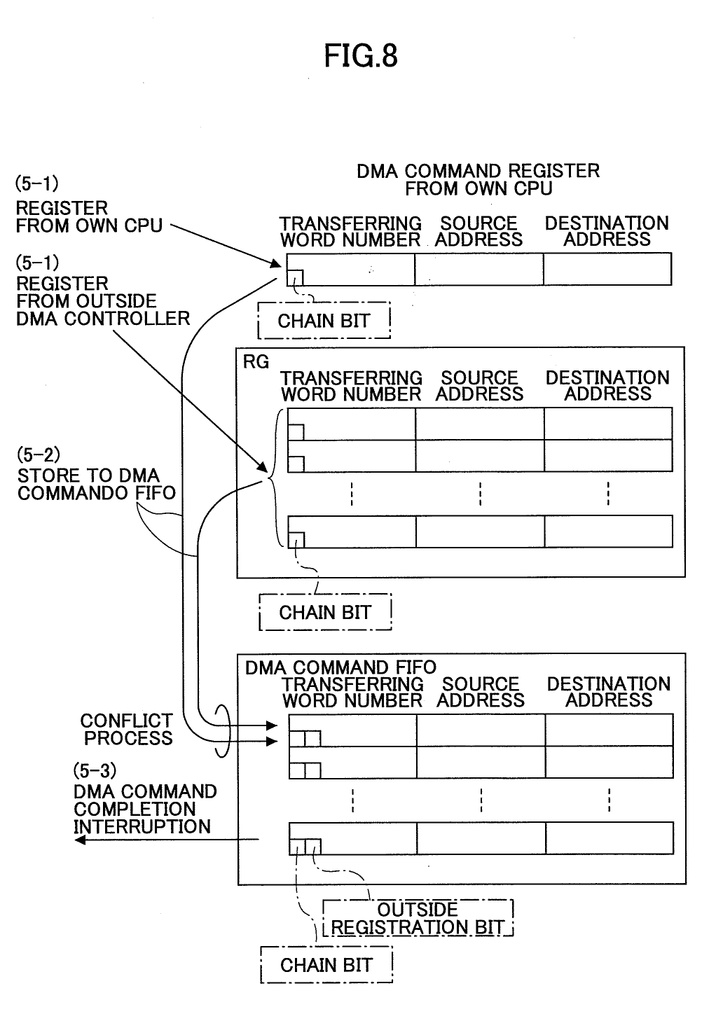

FIG. 8 is a view showing functions of the DMA command storing register RG and a DMA command FIFO memory CFx of the second structural example shown in FIG. 7. The DMA command FIFO memory CFx is used for automatically performing the registered DMA command in registration order. In order to register the DMA command in the DMA command FIFO memory CFx, it is necessary to arrange information necessary for DMA transferring and register it at one time.

Because of this, the DMA command set in the DMA controller DMAx of the own device by the CPU of the own device and a performable DMA command registered in the DMA command storing register RG from the other device are stored for a while in the DMA command FIFO memory CFx.

Operations steps for the DMA transferring using the DMA command FIFO memory CFx are discussed with reference to FIG. 8. FIG. 8 is a view showing functions of the DMA command storing register RG and a DMA command FIFO memory CFx. More specifically, FIG. 8 shows process steps and data structures of stored information in the DMA command FIFO memory CFx, the DMA command storing register RG, and the DMA command from the CPUx of the own device.

First, the DMA command is moved from the CPUx of the own device into a DMA command register (not shown) of the DMA controller DMAx and from the DMA controller DMAx of the external device to the register in an area corresponding to the external device of the DMA command storing register RG (5-1).

The DMA command registered in step S5-1 is stored in the DMA command FIFO memory CFx (5-2). When the DMA command is completed being stored in the DMA command FIFO memory CFx, contents of the register originally registering the DMA command are deleted. In a case where the DMA command is loaded from the DMA command storing register RG to the DMA command FIFO memory CFx, an outside registration bit discussed below is set.

The DMA controller DMAx takes out the DMA command stored in the DMA command FIFO memory CFx in stored order so as to process them. When the processing of the DMA command is completed, the DMA controller DMAx reported that process is completed to the sources of the corresponding DMA commands.

When the DMA commands are stored in the DMA command FIFO memory CFx, the DMA command are registered as a DMA command chain so that plural DMA commands are performed in a designated order. It is normal practice that the DMA command chain makes interruption reporting upon completion to the CPU of the device of each command only when the processing of the last DMA command is completed.

Because of this, a chain bit indicating whether the command is the last DMA command of the chain is provided. A chain bit indicating that there are additional following DMA commands other than the last DMA command is provided. To the DMA command where the chain bit is provided, even if the process is completed, the interruption reporting completion to the CPU is prevented from being generated.

In addition, in a case where the DMA command that has been registered in the DMA command storing register RG is stored in the DMA command FIFO memory CFx, the outside registration bit is set. When a process of the DMA command is completed, reporting the completion to the DMA controller DMAx of the device of the transferring data source or the CPU of the own device is distinguished based on the contents set in the outside registration bit.

In addition, when the CPU sets the DMA command in the DMA controller DMAx where the own device is neither the source nor the destination of the transferring data, by providing both the chain bit of the DMA command FIFO memory CFx and the outside registration bit, generation of interruption for reporting the completion to an unrelated device is stopped. In order to make an interruption for reporting the completion to the source of the DMA command, a DMA command exclusively for interruption reporting the completion is additionally registered.

In order to provide both the chain bit and the outside registration bit, it is necessary to provide areas for the chain bit and the outside registration bit in the DMA command FIFO memory CFx. In addition, in order to provide the chain bit, it is necessary to provide an area for the chain bit in the DMA command storing register RG. In addition, when the DMA command chain is set in the DMA command storing register RG, it is necessary to set the chain bit simultaneously.

For registration in the DMA command storing register RG of the second structural example, it is necessary to set the source address and destination address of the transferring data, the number of transferring words, and the chain bit. Here, for example, in a case where information of the number of transferring words of 32 bits, the source address 32 bits, and the destination address of 32 bits are sent by a data transmission line (outside bus) of address bus 32 bits and data bus 32 bits, if the bit number indicating a maximum value of the transferring word number is equal to or less than 31 bits, by including the chain bit with the transmission bit of the transferring word number, it is possible to expand functions without decreasing efficiency of use of the data transmission line (outside bus) compared to the first structural example.

In the following explanations, an example of operations and operating conditions of the DMA controller and the DMA command FIFO memory is discussed. Here, the DMA controller of each device includes the DMA command FIFO memory and can register plural DMA commands in the DMA command FIFO memory. In order to perform the DMA transferring, the DMA command that is information for performing the DMA transferring is stored in the DMA command FIFO memory. In order to form a chain of the DMA commands, the DMA commands to be continuously performed are stored in the DMA command FIFO memory in a performing order.

The DMA controller performs the DMA command stored in the DMA command FIFO memory in a storing order. In a case where the performed DMA command is write transferring, that is the own device is the source of the DMA transferring, according to the DMA command in the DMA command FIFO memory, a normal write command is performed. This process is repeated at necessary times (number of transferring words) so that the DMA transferring is completed.

In a case where the performed DMA command is read transferring, that is the own device is the destination of the DMA transferring, the destination device (own device) sends (registers) the DMA command to the DMA command FIFO memory of the device of the data source. More specifically, the own device sends this DMA command to the DMA command storing register of the source device.

The device of the data source stores the DMA command set in the DMA command storing register into the DMA command FIFO memory. When the DMA command is stored, the outside registration bit that is a code for identifying a command registered from the outside device is set in the DMA command FIFO memory.

The device of the data source performs the DMA commands stored in the DMA command FIFO memory in a storing order. When performing the DMA command, where the outside registration bit is set, is completed, a message indicating completion is sent to the device of the data source.

The device of the data destination stores the DMA command sent to the device of the source in the DMA command FIFO memory until the message indicating the completion is received from the device of the source. When the message indicating the completion of the DMA command is received, it is regarded that the DMA command is completed so that the DMA command is deleted from the DMA command FIFO memory. If a next DMA command remains, the next DMA command is performed.

In a case where the DMA command to be performed is not related to the own device, that is the own device is neither the source nor destination of the DMA transferring, the own device (DMA command source device) sends the DMA command as a chain command to the DMA command FIFO memory of the device of the source of the DMA transferring data, that is, registers the DMA command in the DMA command storing register. After that, the own device sends a completion notification DMA command for reporting the completion of the DMA command sent to the device of the source by the own device to the DMA command FIFO memory of the device of the source, that is, registers the DMA command in the DMA command storing register.

The completion notification DMA command has no transferring data and a dummy DMA command reports the completion of the DMA transferring to the own device. By storing the completion notification DMA command in the DMA command FIFO memory of the device of the destination of data, the DMA command chain is completed.

The device of the data source performs the DMA commands registered by the DMA command original device (own device) in a storing order of the DMA command FIFO memory so that performance of each DMA command is completed. At this time, since this DMA command is sent as the chain command (where the chain bit is provided), the message of the completion is not sent to the device of the destination at the time when the command is completed.

After that, the device of the source performs the completion notification DMA command (dummy DMA command) received from the DMA command original device (own device). As a result of this, completion of the DMA command where the own device is not the source or the destination of the DNA transferring is reported to the DMA command original device (own device).

After the own device (DMA command original device) receives the completion notification DMA command from the device of the data source, the own device determines that the DMA command is completed so as to delete the DMA command from the DMA command FIFO memory. If a DMA command remains in the DMA command FIFO memory, a next DMA command is performed.

In a case where the DMA command chain is registered in the DMA command FIFO memory, the DMA commands are stored in the DMA command FIFO memory in the order of the chain. The DMA controller performs the DMA commands in a storing order of the DMA command FIFO memory. Even if the DMA command not related to the registered DMA command chain is stored in the chain, since the performing order of the DMA commands is not broken, there is no problem as long as conflict with the transferring area (source and destination) does not happen.

In the embodiment of the present invention, in order to identify that the DMA command to be performed is received from the outside device, the outside registration bit is added to the DMA command FIFO memory. In addition, if the outside registration bit is provided but the chain bit is not provide, after the last DMA write command is performed or simultaneously with performing the DMA write command, the message of completion is sent to the outside device of destination.

The original device of the DMA command receiving this, namely a device of the data destination, determines that the preset (stored) DMA read transferring command is completed so as to delete the DMA command from the DMA command FIFO memory. If a DMA command remains in the DMA command FIFO memory, a next DMA command process is started.

In the meantime, while a case is discussed in the above-discussed example where the bus type data transmission line is used, the same operations are made in a case where a star type or mesh type data transmission line is used. In addition, in a case where a serial data transmission line is used as the data transmission line, where the amount of the data transmission is variable, it is not necessary to provide the DMA command storing register of the second structural example so that direct registration in the DMA command FIFO memory of the outside device can be done.

Advantages for applying the DMA command FIFO memory are as follows.

First, it is possible to easily form the DMA command chain. Second, the CPU loads a DMA command where the own device is neither the source nor destination of the transferring data in the DMA controller (DMA) so that it is possible to send the DMA transferring command to another device. By storing all DMA command in the DMA command FIFO memory so as to be processed, it is possible to easily perform conflict arbitration by a first-in-first out processing method even if the DMA command loaded from the CPU of the own device and the DMA command registered from the outside device into the DMA command storing register (RG) are in conflict with each other.

According to the above discussed embodiments of the present invention, in a case where the read transferring is performed, the DMA command itself of the read transferring is transferred to the DMA controller of the device of data source and the write DMA transferring is performed by the DMA controller of the device of the source. As a result of this, it is possible to reduce the time for use of the data transmission line for the DMA transferring so that the efficiency of use of the data transmission line can be improved.

In addition, the DMA command FIFO memory for storing plural DMA commands set in the own device or from other devices is provided. The DMA commands stored in the DMA command FIFO memory are taken out in first-in-first-out order way and performed. Hence, it is possible to easily perform the conflict control of the DMA commands set in the own device or loaded from other devices.

Furthermore, plural DMA commands as the DMA command chains are stored in the DMA command FIFO memory in the performing order and the chain bit can be set in the DMA commands. Hence, it is possible to easily form the DMA command chain.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

This patent application is based on Japanese Priority Patent Application No. 2006-335545 filed on Dec. 13, 2006, the entire contents of which are hereby incorporated by reference.

What is claimed is:

1. A DMA transferring system with a plurality of devices, the devices being connected to each other by a data transmission line, where DMA transferring is performed among the devices, comprising:
a DMA controller provided in each of the devices performing the DMA transferring and configured to implement a DMA command of write transferring;
wherein the DMA controller includes
a part configured to, in a case where a DMA command of read transferring is selected, send the DMA command of read transferring to the DMA controller of one of the devices sending data of the read transferring; and
a part configured to perform DMA transferring by changing the DMA command of read transferring received from the DMA controller of another of the devices to a DMA command of write transferring in the one of the device sending the DMA command.

2. The DMA transferring system as claimed in claim 1:
wherein the DMA controller further includes
a DMA command FIFO memory configured to store a plurality of the DMA commands set in an own device or another device;
a part configured to take out and perform the DMA commands stored in the DMA command FIFO memory in first-in first-out order; and
a part configured to set an outside registration bit in the DMA command FIFO memory for the DMA command received from the other device, and send a message of completion of performing the DMA command to the device sending the transferring data at the time when performing the DMA command, where the outside registration bit is provided, is completed.

3. The DMA transferring system as claimed in claim 2,
wherein the DMA command FIFO memory includes
a part configured to set a chain bit, the chain bit indicating existence of a following DMA command other then a last DMA command of the chain for a plurality of the DMA command stored in performing order as the DMA command chain, and
a part configured to send a message of completion of performing the DMA command to the device sending the transferring data at the time when performing the DMA command, where the chain bit is not provided but the outside registration bit is provided is completed.

4. A DMA controller provided in a device connected to another device by a data transmission line and performing DMA transferring with the other device, the DMA controller being configured to implement a DMA command of write transferring; the DMA controller comprising:
a part configured to, in a case where a DMA command of read transferring is selected, send the DMA command of read transferring to the DMA controller of the other device sending data of the read transferring; and
a part configured to perform DMA transferring to the device sending the DMA command by changing the DMA command of read transferring received by the DMA controller of the other device to a DMA command of write transferring.

5. The DMA controller as claimed in claim 4, further comprising:
a DMA command FIFO memory configured to store a plurality of the DMA commands set in an own device or the other device;
a part configured to take out and perform the DMA command stored in the DMA command FIFO memory in first-in first-out order; and
a part configured to set an outside registration bit in the DMA command FIFO memory for the DMA command received from the other device, and send a message of completion of performing the DMA command to the device sending the transferring data at the time when performing the DMA command is completed, where the outside registration bit is provided.

6. The DMA controller as claimed in claim 5,
wherein the DMA command FIFO memory includes
a part configured to set a chain bit, the chain bit indicating existence of a following DMA command other then a last DMA command of the chain, for a plurality of the DMA commands stored in performing order as a DMA command chain, and
a part configured to send a message of completion of performing the DMA command to the device sending the transferring data at the time when performing of the DMA command is completed, where the chain bit is not provided but the outside registration bit is provided.

7. A DMA transferring method among devices connected to each other by a data transmission line, the DMA transferring method comprising:
a step of, in a case where a DMA command of read transferring is set in a DMA controller performing the DMA command of write transferring provided in each device, sending the DMA command of read transferring to the DMA controller of the device sending data of the read transferring; and
a step of performing DMA transferring to a device sending the DMA command by changing the DMA command of read transferring received from the DMA controller of other device to a DMA command of write transferring.
